(19) United States
(12) Patent Application Publication
(10) Pub. No.: US 2015/0066542 A1
(43) Pub. Date: Mar. 5, 2015

(54) METHODS FOR FACILITATING PREDICTIVE MODELING FOR MOTOR VEHICLE DRIVER RISK AND DEVICES THEREOF

(71) Applicant: Interactive Driving Systems, Inc, Cape May Court House, NJ (US)

(72) Inventor: Edmund S. Dubens, Cape May Court House, NJ (US)

(73) Assignee: Interactive Driving Systems, Inc, Cape May Court House, NJ (US)

(21) Appl. No.: 14/016,980

(22) Filed: Sep. 3, 2013

(51) Int. Cl. G06Q 40/08

(52) U.S. Cl. CPC G06Q 40/08
USPC 705/4

(57) ABSTRACT

A method, non-transitory computer readable medium, and a performance data management device that collates driver performance data for generating a predictive model of risk associated with insuring a motor vehicle driver. The driver performance data comprises at least historical risk event data and telematic data for a plurality of motor vehicle drivers. A request for driver performance data is received from a modeling computing device, the request comprising one or more predictive modeling parameters including at least demographic information for the motor vehicle driver. A portion of the identified driver performance data is retrieved based at least in part on a match of the demographic information. Personally identifiable information included in the portion of the identified driver performance data is removed. The portion of the driver performance data is provided to the modeling computing device in response to the request.

### FIELD

This technology generally relates to methods and devices for facilitating predictive modeling of motor vehicle driver risk.

### BACKGROUND

Motor vehicle insurance providers generally utilize actuaries in order to determine whether to insure prospective customers and to set insurance underwriting rates or premiums. Actuaries apply information obtained regarding motor vehicle driver(s) associated with prospective customers to predictive models generated based on historical statistical data. The predictive models allow an actuary to analyze factors that may have an impact on the expected cost of future claims associated with the customer, based on past experience with drivers with similar characteristics. The expected cost of future claims generally corresponds with the insurance underwriting rate or premium offered to the prospective customers.

In order to utilize such predictive models, insurance providers generally request permission from prospective customers to obtain a motor vehicle record for each of the motor vehicle drivers associated with the prospective customer, such as from a state department of motor vehicles, for example. Insurance providers can then apply the information included in the motor vehicle records, and any demographic information regarding the motor vehicle drivers, to identify drivers or customers with similar characteristics. Based on the past losses or claims of the identified drivers or customers with similar characteristics, the insurance providers can determine a risk level or class of the motor vehicle drivers and a corresponding underwriting rate for the prospective customer.

Recently, some insurance providers have also utilized telematic devices to provide usage-based insurance to customers. With output from telematic devices, actuaries can determine the risk level of motor vehicle drivers on a regular (e.g., monthly) basis. Accordingly, insurance providers can set the insurance premium for motor vehicle drivers based on relatively small time periods (e.g., per month) rather than setting one premium for a relatively long period of a contract term (e.g., one year). Insurance providers can again utilize predictive models to compare telematic data associated with motor vehicle drivers associated with a customer to data associated with motor vehicle drivers of other customers having associated historical data regarding losses or claims, to determine the risk level or class of the customer.

However, the predictive models used by actuaries are limited to historical data acquired by the insurance provider and associated with past or current customers of the insurance provider. Additionally, actuaries lack significant data that would otherwise be useful for adequately assessing the risk of insuring a prospective customer and for setting premiums for prospective and current customers. Absent sufficient data, insurance providers face an increased risk of making imprudent underwriting decisions and/or generating offers or premiums with unfavorable rates.

### SUMMARY

A method for facilitating predictive modeling for motor vehicle driver risk includes collating, with a performance data management device, driver performance data for generating a predictive model of risk associated with insuring a motor vehicle driver. The driver performance data comprises at least historical risk event data and telematic data for a plurality of motor vehicle drivers. A request for driver performance data is received, with the performance data management device, from a modeling computing device, the request comprising one or more predictive modeling parameters including at least demographic information for the motor vehicle driver. A portion of the identified driver performance data is retrieved, with the performance data management device, based at least in part on a match of the demographic information. Personally identifiable information included in the portion of the identified driver performance data is removed with the performance data management device. The portion of the driver performance data is provided, with the performance data management device, to the modeling computing device in response to the request.

A non-transitory computer readable medium having stored thereon instructions for facilitating predictive modeling for motor vehicle driver risk comprising machine executable code which when executed by a processor, causes the processor to perform steps including collating driver performance data for generating a predictive model of risk associated with insuring a motor vehicle driver. The driver performance data comprises at least historical risk event data and telematic data for a plurality of motor vehicle drivers. A request for driver performance data is received from a modeling computing device, the request comprising one or more predictive modeling parameters including at least demographic information for the motor vehicle driver. A portion of the identified driver performance data is retrieved based at least in part on a match of the demographic information. Personally identifiable information included in the portion of the identified driver performance data is removed. The portion of the driver performance data is provided to the modeling computing device in response to the request.

A performance data management device includes a processor coupled to a memory and configured to execute programmed instructions stored in the memory including collating driver performance data for generating a predictive model of risk associated with insuring a motor vehicle driver. The driver performance data comprises at least historical risk event data and telematic data for a plurality of motor vehicle drivers. A request for driver performance data is received from a modeling computing device, the request comprising one or more predictive modeling parameters including at least demographic information for the motor vehicle driver. A portion of the identified driver performance data is retrieved based at least in part on a match of the demographic information. Personally identifiable information included in the portion of the identified driver performance data is removed. The portion of the driver performance data is provided to the modeling computing device in response to the request.

This technology provides a number of advantages including methods, non-transitory computer readable media, and devices that facilitate predictive modeling of insurance provider risk. With this technology, a comprehensive profile of data useful for making underwriting decisions and determining rates is collected by a third party intermediary performance data management device from a plurality of performance data source devices. Insurance providers, actuaries, and researchers, for example, can interface with the performance management device to receive an increased amount of relevant data from which to make underwriting decisions and generate rates.

### BRIEF DESCRIPTION OF THE DRAWINGS

FIG. 1 is a block diagram of an exemplary network environment which incorporates an exemplary performance data management device coupled to modeling computing devices and performance data source devices;

FIG. 2 is a flowchart of an exemplary method for facilitating a predictive modeling of motor vehicle driver risk; and

FIG. 3 is an exemplary table including exemplary historical risk events and telematic data and corresponding source of the historical risk events and telematic data.

### DETAILED DESCRIPTION

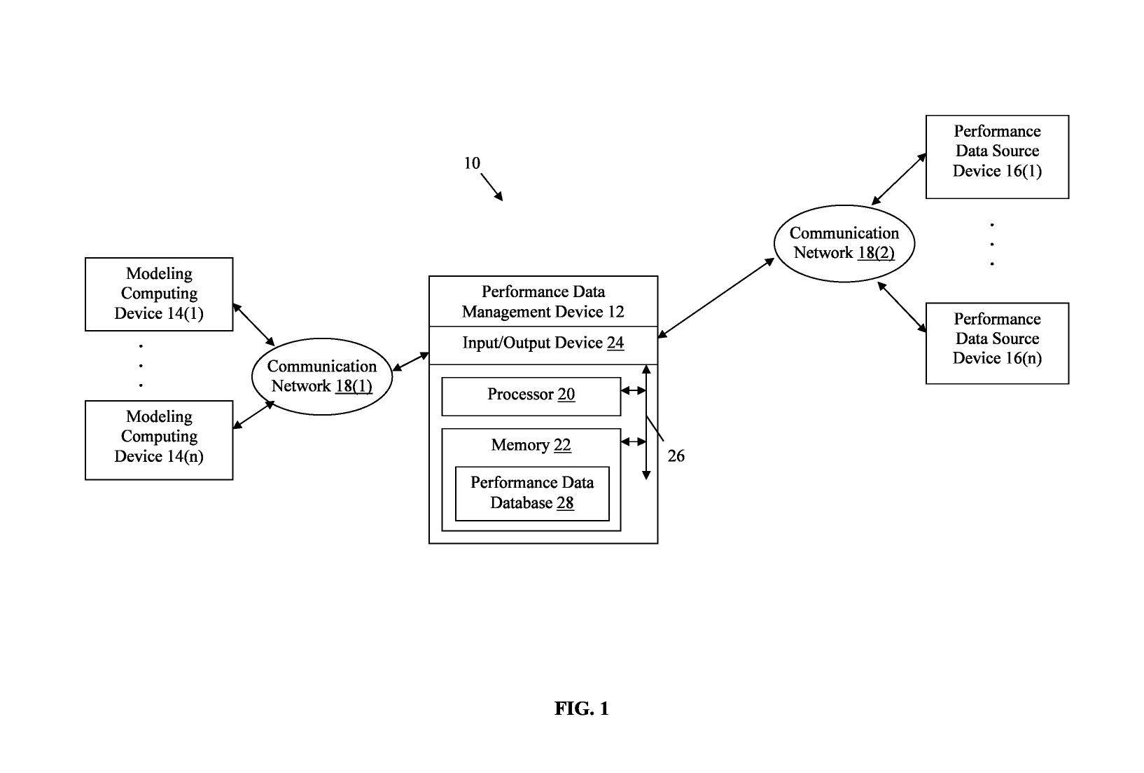

An exemplary network environment 10 with an performance data management device 12 coupled to modeling computing devices 14(1)-14(n) and performance data source devices 16(1)-16(n) by communication networks 18(1), and 18(2) is illustrated in FIG. 1, although this network environment 10 can include other numbers and types of systems, devices, and elements in other configurations. While not shown, the network environment 10 also may include additional network components such as routers and switches which are well known to those of ordinary skill in the art and thus will not be described here. This technology provides a number of advantages including methods, non-transitory computer readable media, and devices that facilitate predictive modeling of motor vehicle driver risk and allow actuaries to make more effective underwriting decisions and set more appropriate rates.

The performance data management device 12 includes a processor 20, a memory 22, and an input/output device 24, which are coupled together by a bus 26 or other link, although other numbers and types of systems, devices, components, and elements in other configurations and locations can also be used. The processor 20 in the performance data management device 12 executes a program of stored instructions for one or more aspects of the present technology, as described and illustrated by way of the examples herein, although other types and numbers of processing devices and configurable hardware logic could be used and the processor 20 could execute other numbers and types of programmed instructions.

The memory 22 in the performance data management device 12 stores these programmed instructions for one or more aspects of the present technology as described and illustrated herein, although some or all of the programmed instructions could be stored and executed elsewhere. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the processor 20, can be used for the memory 22.

In this example, the memory 22 includes a performance data database 28. The performance data database 28 is a repository for performance data including historical risk event and telematic data obtained from the performance data source devices 16(1)-16(n) and associated with each of a plurality of motor vehicle drivers, as described and illustrated in more detail later. In other examples, the memory 22 can store other information in other formats and the information stored in the performance data database 28 can be stored elsewhere.

The input/output device 26 in the performance data management device 12 is used to operatively couple and communicate between the performance data management device 12, the modeling computing devices 14(1)-14(n) and the performance data source devices 16(1)-16(n) via the communication networks 18(1) and 18(2), although other types and numbers of connections and configurations can also be used. By way of example only, the communication networks 18(1) and 18(2) can include one or more local area networks or wide area networks, for example, and can use TCP/IP over Ethernet and industry-standard protocols, including hypertext transfer protocol (HTTP) and secure HTTP (HTTPS), although other types and numbers of communication networks, such as a direct connection, modems and phone lines, e-mail, and wireless and hardwire communication technology, each having their own communications protocols, can also be used.

The modeling computing devices 14(1)-14(n) in this example each include a processor, a memory, an input/output device, an input device, and a display device, which are coupled together by a bus or other link. The modeling computing devices 14(1)-14(n) can also have other numbers and types of systems, devices, components, and elements in other configurations and locations. The modeling computing devices 14(1)-14(n) can be mobile computing devices, smartphones, tablets, laptops, desktop computers, or any combination thereof. Insurance providers, actuaries, and/or researchers, for example, can use the modeling computing devices 14(1)-14(n) to interface with the performance data management device 12 to request performance data and other information regarding motor vehicle drivers, as described and illustrated in more detail later.

The performance data source devices 16(1)-16(n) in this example each include a processor, a memory, and an input/output device, which are coupled together by a bus or other link. The performance data source devices 16(1)-16(n) can also have other numbers and types of systems, devices, components, and elements in other configurations and locations. In some examples, the performance data source devices 16(1)-16(n) include one or more server computing devices hosted by providers of performance data and/or one or more telematics devices, as described and illustrated in more detail later.

Although examples of the performance data management device 12, modeling computing devices 14(1)-14(n) and performance data source devices 16(1)-16(n), which are coupled together via the communication networks 18(1) and 18(2) are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s). Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTN Packet Data Networks (PDNs), the Internet, intranets, or combinations thereof.

The examples may also be embodied as a non-transitory computer readable medium having programmed instructions stored thereon for one or more aspects of the present technology as described and illustrated by way of the examples herein. The programmed instructions, when executed by a processor, cause the processor to carry out the steps necessary to implement one or more methods of the examples, as described and illustrated herein.

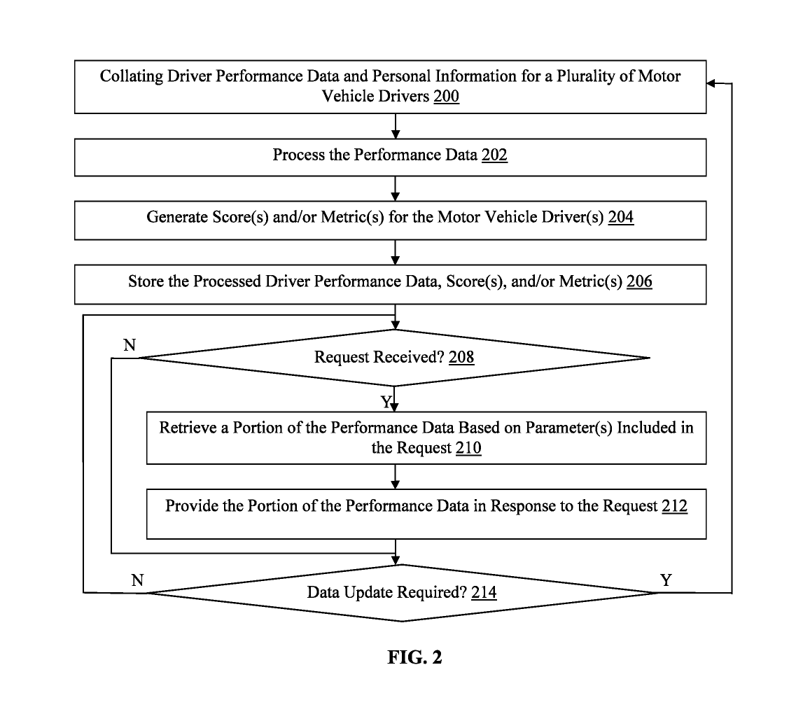

Exemplary methods and devices for facilitating predictive modeling of motor vehicle driver risk will now be described with reference to FIGS. 1-3. Referring more specifically to FIG. 2, in step 200 the performance data management device 12 collates driver performance data and personal information for a plurality of motor vehicle drivers from the performance data source devices 16(1)-16(n). The performance data includes at least historical risk event and telematic data in this example, although other types and amounts of performance data can also be obtained in step 202. Additionally, the performance data is obtained from the performance data source devices 16(1)-16(n) using the input/output device 26 and the communication network 18(2).

The historical risk events include at least incidents, collisions, and violations and the telematic data includes information regarding the operation of vehicles associated with the motor vehicle drivers, although the historical risk events can comprise other types and numbers of events and the telematic data can comprise other types and amounts of data. Accordingly, in this example the performance data source devices 16(1)-16(n) can include one or more server computing devices hosted by a government agency, such as a state department of motor vehicles and/or the Federal Motor Carrier Safety Administration, which are configured to store and selectively provide motor vehicle records and/or violations (e.g., road side inspection violations) for at least some of the motor vehicle drivers.

The performance data source devices 16(1)-16(n) can also include one or more server computing devices associated with insurance companies, brokers, and/or leasing companies, for example, which are configured to store and selectively provide claim information. The claim information can include information regarding incidents and/or collisions for the motor vehicle drivers associated with customers of the insurance companies, brokers, and/or leasing companies, for example.

Additionally, the performance data source devices 16(1)-16(n) in this example include telematics device(s) attached to computing device(s) in motor vehicles associated with the motor vehicle drivers, and/or server computing device(s) which store the telematics data output by the telematic devices. The telematic devices are configured to transmit, and/or the server computing device(s) are configured to store and selectively provide, information regarding the operation of the motor vehicles associated with the motor vehicle drivers. Exemplary telematic data includes speed, braking, acceleration, idling, miles per gallon, steering, reversing, Global Positioning System (GPS) location information, time driven, and/or miles driven, for example, although any other telematic data can also be obtained by the performance data management device 12.

Optionally, the performance data source devices 16(1)-16(n) can further include server computing device(s) maintained by fleet operators and configured to store and selective provide performance data including historical risk events such as company policy violations and complaints submitted by third parties, for example, for motor vehicle drivers associated with the fleet operator. Additionally, the performance data source devices 16(1)-16(n) can also include other types and numbers of devices configured to store and/or selectively provide other performance data upon request from the performance data management device 12.

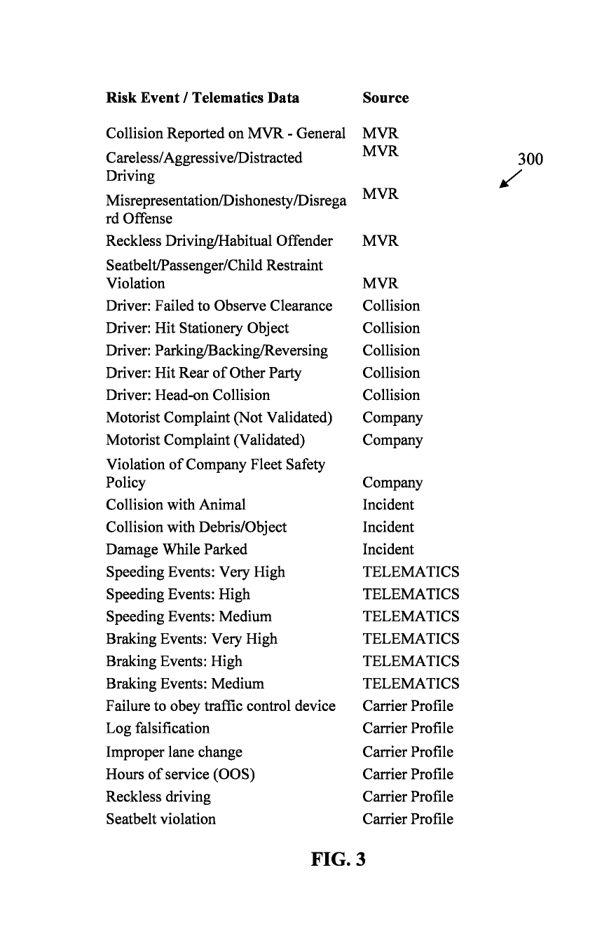

Referring to FIG. 3, an exemplary table 300 including exemplary historical risk events included in the performance data obtained in step 200 and telematic data and corresponding source of the events and data is illustrated. In this example, the table 300 includes exemplary historical risk events such as “Reckless Driving/Habitual Offender,” “Driver: Head-on Collision,” “Motorist Complaint (Validated),” “Damage While Parked,” “Speeding Events: Very High,” and “Improper lane change,” for example, although any other risk events can be included in the performance data obtained by the performance data management device 12 in step 200.

The personal information obtained in step 200 can include demographic information, credit history or score, and/or educational attainment, for example, although other personal information can also be obtained. The personal information can be obtained from the performance data source devices 16(1)-16(n) along with motor vehicle records or insurance claim records for the drivers, for example. In other examples, the personal information can be obtained from one of the performance data source devices 16(1)-16(n) associated with a credit reporting agency or other third party device not configured to provide performance data to the performance data management device 12, for example. Other types and sources of personal information for the motor vehicle drivers can also be used by the performance data management device 12 in step 200.

In step 202, the performance data management device 12 processes the obtained performance data. In this example, the data can be aggregated by the performance data management device 12 to generate driver records for each of the motor vehicle drivers. The driver records can include performance data associated with each of the drivers as obtained from the performance data source devices 16(1)-16(n).

For example, a motor vehicle record for a motor vehicle driver may be obtained from one of the performance data source devices 16(1)-16(n) associated with a state department of motor vehicle and insurance claims associated with the motor vehicle driver may be obtained from one of the performance data source devices 16(1)-16(n) associated with an insurance provider. In this example, the motor vehicle record and insurance claims can be aggregated and associated with the motor vehicle driver in a driver record, for example.

The driver records can be generated using personally identifiable information (e.g., names or social security numbers) included in the performance data and/or personal information obtained in step 202, for example. Additionally, a subset of the performance data can be aggregated for motor vehicle drivers sharing one or more characteristics (e.g., age, geographic location, or employed by a same fleet operator). Other methods of aggregating the obtained performance data can also be used.

Subsequent to aggregating the performance data into driver records, for example, the performance data management device 12 can then process the performance data to remove the personally identifiable information from the driver records. By removing personally identifiable information, privacy of motor vehicle drivers will not be compromised and insurance provider customers will not be explicitly disclosed to other insurance providers requesting performance data from the performance data management device 12, as described and illustrated in more detail later.

In other examples, the performance data management device 12 can process the performance data to normalize corresponding data obtained from different performance data source devices 16(1)-16(n), identify risk events in raw data, filter the data, analyze the data, and/or generate statistical information (e.g., averages) based on the data. Other methods of processing the performance data can also be used by the performance data management device 12.

In step 204 the performance data management device 12 optionally generates one or more scores and/or metrics for one or more of the motor vehicle drivers. The one or more generated scores for the motor vehicle drivers can indicate a relative risk level of the drivers. In one example, a score can be assigned for one or more of the risk events and/or telematic events identified in the telematic data obtained in step 200. The score for each of the risk and/or telematic events can be based on a severity of the event and/or a time period likely required to change the behavior of the motor vehicle driver such that the risk of the event occurring in the future is minimized, for example.

Optionally, the one or more scores for each of the risk and/or telematic events can be reduced based on the age of the one or more associated events. Accordingly, events occurring further in the past can be assigned a lower score than events occurring relatively recently and of otherwise corresponding severity. Based on the score for each of the risk and/or telematic event(s), an overall score can be generated for one or more of the motor vehicle drivers. Other methods of generating risk event, telematic event, and/or overall scores for the motor vehicle drivers can also be used. The one or more metrics generated by the performance data management device 12 in step 204 can include collisions, license violations, telematic events, or risk events per million miles or per the trailing three or five year period, for example, although any other metric(s) can also be used.

In step 206, the performance data management device 12 stores the processed driver performance data, and optionally the one or more scores and/or metrics generated in step 204, in the memory 22, such as in the performance data database 28, for example. In examples in which the performance data management device 12 processes the obtained data to generate driver records, the driver records can be stored in the performance data database 28. In examples in which one or more scores and/or metrics are generated for the motor vehicle drivers, the one or more scores and metrics also can be included in associated driver records in the performance data database 28, for example. Other methods of storing the processed performance data can also be used and the processed performance data can be stored elsewhere.

In step 208, the performance data management device 12 determines whether a request for performance data is received from a user of one of the modeling computing devices 14(1)-14(n). The user can be a representative of an insurance provider, an actuary, or a researcher, for example, or any other user interested in receiving and/or analyzing a portion of the data stored by the performance data management device 12. In this example, the user of the one of the modeling computing devices 14(1)-14(n) can interface with the performance data management device 12, such as by using one or more web pages provided by the performance data management device 12.

For example, the one or more web pages can include a data request form web page including input fields for various parameters. Upon selecting a submit button, for example, of the data request form web page using an input device of one of the modeling computing devices 14(1)-14(n), the request and associated parameters are sent to the performance data management device 12. Accordingly, if the performance data management device 12 determines in step 208 that a request is received from one of the modeling computing devices 14(1)-14(n), then the Yes branch is taken to step 210.

In step 210, the performance data management device 12 retrieves at least a portion of the driver performance data based on the parameters included in the received request. In one example, an actuary representing an insurance provider can submit a request including parameters such as personal information including demographic attributes indicating a male aged 50-60 living in New Jersey. Optionally, the demographic information can be associated with a current or prospective customer of the insurance provider for which the actuary would like to determine an insurance premium, for example.

In response to the received request, the performance data management device 12 can query the performance data database 28 based on the submitted parameters and retrieve the driver records matching the parameters included in the request. Accordingly, in this example, the performance data management device 12 retrieves any driver records associated with males aged 50-60 living in New Jersey from the performance data database 28. Any other parameters can be associated with input fields on the data request form web page and included in the request received from one of the modeling computing devices 14(1)-14(n).

In step 212, the performance data management device 12 provides at least the portion of the driver performance data retrieved in step 210 to the requesting one of the modeling computing devices 14(1)-14(n). The portion of the performance data can be provided in the format of the driver records retrieved from the performance data database 28 and/or can be processed, such as to place the data in a readable format for example.

Optionally, the performance data management device 12 can further process the retrieved portions of the performance data to generate one or more statistics. For example, the performance data management device 12 can be configured to generate a statistic indicating the average number of license violations in the last three years for males aged 50-60 living in New Jersey in the example described and illustrated earlier. Any other types of statistics can be generated and the retrieved portion of the performance data can be processed by the performance data management device 12 in other manners.

In order to provide the retrieved portion of the performance data to the requesting one of the modeling computing devices 12, the performance data management device can further output the retrieved portion of the performance data to a generated results web page. The results web page can be output to the requesting one of the modeling computing devices 14(1)-14(n) using the input/output device 26 and communication network 18(1), for example. The results web page can be provided to a web browser of the one of the modeling computing devices 14(1)-14(n). Alternatively, a link to the results web page can be sent by the performance data management device 12 to the user of the one of the modeling computing devices 14(1)-14(n) using contact information (e.g., an e-mail address) submitted to and stored by the performance data management device 12 during a user registration process.

In other examples, the performance data management device 12 can send the user of the one of the modeling computing devices 14(1)-14(n) a Portable Data Format (PDF) document, spreadsheet documents, or a document of another format or file type, for example, including the retrieved portion of the performance data using contact information for the user. Other methods of providing the retrieved portion of the performance data can also be used. Additionally, different methods of providing the portion of the performance data can be used for different users of the modeling computing devices 14(1)-14(n) based on preferences received and stored by the performance data management device 12 during a user registration process, for example.

Accordingly, the user of the one of the modeling computing devices 14(1)-14(n), such as an actuary in this example, can retrieve from the performance data management device 12, a more comprehensive profile of information for motor vehicle drivers sharing one or more characteristics with a current or prospective customer. The actuary can then model or otherwise analyze the driver records and/or the provided portion of the performance data in order to determine an appropriate premium for a prospective or current customer, for example. In addition to receiving a relatively comprehensive profile of information for other motor vehicle drives, the actuary can also retrieve performance data associated with more motor vehicle drivers than would otherwise be available based on the data maintained by the insurance provider, which only includes information for past and current customers of the insurance provider.

Referring back to step 208, if the performance data management device determines that a request has not been received, or subsequent to providing the retrieved portion of the performance data in step 212, the performance data management device 12 proceeds to step 214. In step 214, the performance data management device 12 determines whether a data update is required. Accordingly, the performance data management device 12 can be configured to automatically and periodically update the obtained performance data such as once a month or once a quarter for example. The update period can be established by an administrator of the performance data management device 12 and stored in the memory 22, for example.

In other examples, an update of the performance data is initiated manually, such as by an administrator of the performance data management device 12. Other methods of updating the performance data can also be used and a data update can be required at different times for various of the performance data source devices 16(1)-16(n). Accordingly, if the performance data management device 12 determines in step 214 a data update is required, then the Yes branch is taken to step 200 and performance data is obtained as described and illustrated earlier.

In subsequent iterations of step 200, the performance data management device 12 can be configured to retrieve only performance data modified by one or more of the performance data source devices 16(1)-16(n) since the performance data was previously obtained. Alternatively, all of the performance data can be obtained from one or more of the performance data source devices 16(1)-16(n) and compared with the performance data stored in the memory 22 to identify any changes.

Accordingly, in some examples, personally identifiable information can be maintained and associated with the driver records stored in the performance data database 28 to allow the performance data management device 12 to determine whether a driver record should be modified based on updated performance data obtained from one or more of the performance data source devices 16(1)-16(n). In these examples, personally identifiable information can be removed by the performance data management device 12 prior to providing the retrieved portion of the performance data in step 212, instead of during the processing of the performance data performed in step 202. Other methods of updating the driver performance data can also be used.

Referring back to step 214, if the performance data management device 12 determines a data update is not required, then the performance data management device 12 proceeds back to step 208 and determines whether a request for performance data is received, as described and illustrated earlier. Accordingly, the performance data management device 12 effectively waits for a request for performance data from a user of one of the modeling computing devices 14(1)-14(n) whenever the performance data is not currently being updated.

Accordingly, by this technology, an intermediary performance data management device 12 advantageously facilitates predictive modeling for motor vehicle driver risk by providing users with an increased amount of performance data for an increased number of motor vehicle drivers. With this technology, actuaries and other users of the performance data management device 12 can generate more effective predictive models of the insurance risk of a motor vehicle driver and thereby make better and more informed underwriting decisions and generate more favorable premiums for current and prospective customers.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method for facilitating predictive modeling for motor vehicle driver risk, the method comprising:
collating, with a processor of a performance data management device executing one or more instructions stored in a memory, driver performance data, wherein the driver performance data is retrieved from a plurality of performance data source devices and stored in a performance data database of the memory and the driver performance data comprises at least historical risk event data and telematic data for a plurality of motor vehicle drivers;
receiving, with the performance data management device, a request for driver performance data from a modeling computing device, the request comprising one or more predictive modeling parameters including at least demographic information;
retrieving, with the processor of the performance data management device executing one or more instructions stored in the memory, at least a portion of the driver performance data from the performance data database for one or more of the motor vehicle drivers matching the demographic information included in the request;
removing, with the processor of the performance data management device executing one or more instructions stored in a memory, at least any personally identifiable information included in the retrieved portion of the identified driver performance data; and
providing, with the performance data management device, the portion of the driver performance data to the modeling computing device in response to the request, the portion of the driver performance data comprising at least a portion of the historical risk event and telematic data for one or more of the plurality of motor vehicle drivers.

2. The method of claim 1, wherein the collating further comprises aggregating the driver performance data into driver records each associated with one of the plurality of motor vehicle drivers based on personally identifiable information included in the driver performance data.

3. The method of claim 1, wherein:
at least a portion of the historical risk event data is obtained from at least one state department of motor vehicles, a federal government agency, or a current or past insurance provider for the motor vehicle drivers; and
the historical risk event data comprises incident, collision, or violation data associated with the motor vehicle drivers.

4. The method of claim 1, wherein the performance data comprises motor vehicle records for the motor vehicle drivers, road side inspection data for the motor vehicle drivers, telematics data retrieved from one or more motor vehicles associated with the motor vehicle drivers, or insurance claim records associated with the motor vehicle drivers.

5. The method of claim 1, further comprising:
generating, with the processor of the performance data management device executing one or more instructions stored in a memory, at least one of one or more metrics based on the driver performance data or an overall score for each of the motor vehicle drivers based on one or more of the historical risk event data or the telematic data; and
providing, with the performance data management device, one or more of the overall scores or one or more of the metrics in response to the received request from the modeling computing device.

6. A non-transitory computer readable medium having stored thereon instructions for facilitating predictive modeling for motor vehicle driver risk comprising machine executable code which when executed by a processor, causes the processor to perform steps comprising:
collating driver performance data comprising at least historical risk event data and telematic data for a plurality of motor vehicle drivers;
receiving a request for driver performance data from a modeling computing device, the request comprising one or more predictive modeling parameters including at least demographic information;
retrieving at least a portion of the driver performance data for one or more of the motor vehicle drivers matching the demographic information included in the request;
removing at least any personally identifiable information included in the portion of the identified driver performance data; and
providing the portion of the driver performance data to the modeling computing device in response to the request, the portion of the driver performance data comprising at least a portion of the historical risk event and telematic data for one or more of the plurality of motor vehicle drivers.

7. The medium of claim 6, wherein the collating further comprises aggregating the driver performance data into driver records each associated with one of the plurality of motor vehicle drivers based on personally identifiable information included in the driver performance data.

8. The medium of claim 6, wherein:
at least a portion of the historical risk event data is obtained from at least one state department of motor vehicles, a federal government agency, or a current or past insurance provider for the motor vehicle drivers; and
the historical risk event data comprises incident, collision, or violation data associated with the motor vehicle drivers.

9. The medium of claim 6, wherein the performance data comprises motor vehicle records for the motor vehicle drivers, road side inspection data for the motor vehicle drivers, telematics data retrieved from one or more motor vehicles associated with the motor vehicle drivers, or insurance claim records associated with the motor vehicle drivers.

10. The medium of claim 6, further having stored thereon instructions that when executed by the processor cause the processor to perform steps further comprising:
generating at least one of one or more metrics based on the driver performance data or an overall score for each of the motor vehicle drivers based on one or more of the historical risk event data or the telematic data; and
providing one or more of the overall scores or one or more of the metrics in response to the received request from the modeling computing device.

11. A performance data management device, comprising:
a processor coupled to a memory and configured to execute programmed instructions stored in the memory comprising:
collating driver performance data comprising at least historical risk event data and telematic data for a plurality of motor vehicle drivers;
receiving a request for driver performance data from a modeling computing device, the request comprising one or more predictive modeling parameters including at least demographic information;
retrieving at least a portion of the driver performance data for one or more of the motor vehicle drivers matching the demographic information included in the request;
removing at least any personally identifiable information included in the portion of the identified driver performance data; and
providing the portion of the driver performance data to the modeling computing device in response to the request, the portion of the driver performance data comprising at least a portion of the historical risk event and telematic data for one or more of the plurality of motor vehicle drivers.

12. The device of claim 11, wherein the collating further comprises aggregating the driver performance data into driver records each associated with one of the plurality of motor vehicle drivers based on personally identifiable information included in the driver performance data.

13. The device of claim 11, wherein:
at least a portion of the historical risk event data is obtained from at least one state department of motor vehicles, a federal government agency, or a current or past insurance provider for the motor vehicle drivers; and
the historical risk event data comprises incident, collision, or violation data associated with the motor vehicle drivers.

14. The device of claim 11, wherein the performance data comprises motor vehicle records for the motor vehicle drivers, road side inspection data for the motor vehicle drivers, telematics data retrieved from one or more motor vehicles associated with the motor vehicle drivers, or insurance claim records associated with the motor vehicle drivers.

15. The device of claim 11, wherein the processor is further configured to execute programmed instructions stored in the memory further comprising:
generating at least one of one or more metrics based on the driver performance data or an overall score for each of the motor vehicle drivers based on one or more of the historical risk event data or the telematic data; and
providing one or more of the overall scores or one or more of the metrics in response to the received request from the modeling computing device.
